(19) United States
(12) Patent Application Publication
(10) Pub. No.: US 2009/0011079 A1
(43) Pub. Date: Jan. 8, 2009

(54) Hard Coated Confectionary Having A Consumable Soft Chewing Core With An Active And Method For Making Same

(75) Inventors: Harry J. Overly, III, Huntersville, NC (US); Mark B. Jones, Cleveland, NC (US); Thomas B. Yates, Statesville, NC (US); Richard C. Zulman, Cornelius, NC (US)

Correspondence Address: FITCH EVEN TABIN AND FLANNERY, 120 SOUTH LA SALLE STREET, SUITE 1600, CHICAGO, IL, 60603-3406, US

(73) Assignee: BESTSWEET, INC., Mooresville, NC (US)

(21) Appl. No.: 11/772,631

(22) Filed: Jul. 2, 2007

(51) Int. Cl. A23G 4/06; A23G 4/18

(52) U.S. Cl. 426/5; 426/601; 426/602

(57) ABSTRACT

A hard coated confectionary product having a consumable, soft, fortified, high solids and chewy core encapsulated in a hard consumable coating and a method for making the fortified confectionary is described.

### FIELD

The present invention is generally directed to a hard coated confectionary product having a consumable, fortified, soft chewing core and hard consumable coating and a method for making the product. More particularly, the confectionary product has a high solids core which includes a particulate active, such as an antacid, surrounded by a sweet hard consumable coating.

### BACKGROUND

Hard coated candy products for delivery of active ingredients are known in the confectionary art. U.S. Patent Publication 2003/0017202 by Bunick et al. describes a coated soft core consumable product with an active that can include calcium carbonate. If the active has an objectionable taste, it is coated with a taste masking agent (see paragraph 0017). Bunick also describes using excipients (inert substances) in the core where the excipient may include gums (see paragraph 0028). Bunick, however, has to focus on the particle size of his active or drug, and the weight ratio of active to shell. Further, he has to use a taste masking agent to mask off flavors of the active. In short he does not use natural confectionary ingredients, such as gum/emulsifier/fat/coating to deliver an active, such as an antacid, in a confectionary product.

U.S. Pat. No. 5,637,313 to Chau et al. describes a soft chewable dosage form which includes a matrix of hydrogenated starch hydrolysate, a water soluble bulking agent and a water insoluble bulking agent. Gums are described as water soluble bulking agents (see column 4, line 67) and calcium carbonate is described as a bulking agent (column 4, lines 21-26). But Chau focuses on an uncooked soft chew product. Moreover, Chau does not use fat, an emulsifier and gum to achieve a high loading of solids which includes calcium carbonate or other antacid. Further he does not use an additional solids loading, such as with sugars, which would naturally hide any off flavors created by the active or antacid. While Chau does contemplate hard coating as an option, Chau does not suggest the use of the hard coating with a cooked confectionary product to stabilize or preclude the confection or antacid from picking up water and adversely affecting the organoleptic properties of the confectionary product. Moreover, when Chau has been practiced, it has been observed that Chau's uncooked product is extremely soft and not readily formable for subsequent coating.

U.S. Pat. No. 5,013,716 to Cherukuri et al. describes an uncoated confection which includes an active/drug, a gum base which may include calcium carbonate (column 9, line 4) and xanthan gum which may be used as a softener (column 9, line 45). Cherukuri, however, is primarily concerned with a taste masking agent, and does not use the combination of gum/emulsifier/fat/coating to deliver an active, such as an antacid, in a coated confectionary product. Nor does Cherukuri suggest the use of the hard coating with a cooked confectionary product to stabilize or preclude the confection or the antacid from picking up water and adversely affecting the organoleptic properties of the confectionary product.

Heretofore, stable soft chew confectionary delivery systems have been either unknown or difficult to make. These types of confections, especially those confections which are used for the delivery of active ingredients such as antacids, vitamins, analgesics and antipyretics (such as acetaminophen), typically have been hard to stabilize over long periods of time by virtue of their tendency to pick up water under humid conditions or loose water under dry conditions. Not only the active may be hygroscopic, but the confection itself may be hygroscopic due to the high moisture content of chewy confections and high Equilibrium Relative Humidity (ERH) of the confection. As used herein, ERH is the equilibrium state at which the confectionery product neither absorbs nor loses moisture to the environment.

### SUMMARY

Described herein is a shelf life stable coated chewable product having a soft, chewable, cooked, confectionary core with gum, fat, an emulsifier, and large amounts of particulate active, such as an antacid, which are uniformly dispersed in the core. While the solid, particulate active may include vitamins, analgesics and antipyretics in lieu of or addition to particulate antacid, in an important aspect, the particulate active is an antacid and the antacid is an alkaline antacid mineral.

The coated product provides great versatility and stability in commercial distribution channels because it resists drying out in the core in hot dry conditions and resists taking up water and becoming soft in humid conditions. This is an important problem which has to be addressed for a chewy matrix which is hygroscopic and which product may have a solid, particulate active, such as an antacid, which also may be hygroscopic. The edible coating, which encapsulates the cooked, soft, chewable and active fortified confectionary core, provides a chewable product with a highly improved taste profile and also provides the chewable core with organoleptic stability. Improved taste is achieved without special taste masking agents or encapsulating the individual antacid particles prior to mixing them into what would become an encapsulated core. As for stability, the coating which encapsulates the hygroscopic core precludes the cooked, soft, antacid/confectionary core from taking up water or loosing water and deleteriously affecting the organoleptic properties of the coated product. The coating is thin and completely surrounds or encapsulates the cooked, soft, antacid/active/confectionary core and has a thickness which is effective for protecting the core from a water loss or gain of not more than about 2 weight percent for at least 18 months at ambient temperature and adversely hardening or softening the confectionary core. The coating generally is from about 1 to 2 mm thick, comprises from about 20 to 28 weight percent of the finished product which is the core encapsulated in the coating, and in an important aspect, the coating comprises substantially crystallized sugar and/or sugar alcohols.

In the core, the gum keeps the cooked, soft, confectionary core soft and chewy. The combination of gum/emulsifier/fat provides a cooked matrix for the core which keeps the fat within the matrix to deliver a solid, particulate active, such as an antacid, in a coated confectionary product with a soft non-gritty core. Keeping the fat component with the matrix core keeps the product with a soft and chewy core and organoleptically acceptable. Further, depending upon the atmospheric conditions, the coating protects the confectionary core from drying out resulting in an undesirably gritty product, or alternatively as discussed above, protects the particulate antacid in the core from taking up or loosing water and adversely affecting the organoleptic properties of the core, e.g. the core resisting becoming too soft or too hard. The coating also provides a burst of flavor which counteracts the chalky taste profile often associated with a particulate mineral antacid. In an important aspect, the core is non-aerated or does not have gas blown through it.

In another aspect, a method for making the coated chewable antacid product and loading it with large amounts of antacid also is described herein. The solids in the product are added in two stages, as a part of a slurring process before cooking with the removal of water during and after cooking. After cooking additional solids are added into the cooked product.

### DESCRIPTION OF THE DRAWING

FIG. 1 is a schematic drawing of the process described herein.

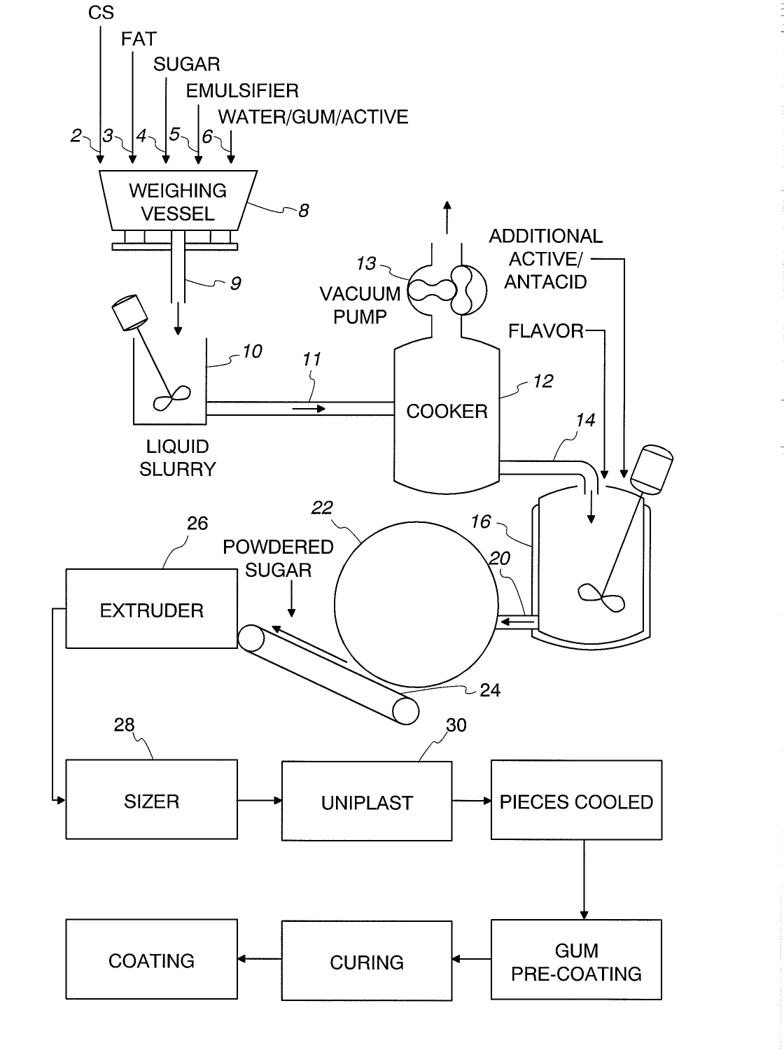

### DETAILED DESCRIPTION

The product described herein includes a hard consumable encapsulating coating, such as a sugar coating, and a fortified chewy cooked core. The coated chewy core will have a at least about 10 weight percent (dry basis) particulate active, generally at least 30 and preferably from 30 to 40 weight percent (dry basis), and most preferably from 33 to 36 weight percent (dry basis) particulate active; about 0.1 to about 2, weight percent (dry basis), and preferably from about 0.5 to about 1 weight percent (dry basis) gum; from about 20 to about 40 weight percent, and preferably from 30 to 35 weight percent (dry basis), corn syrup; from about 20 to about 40 weight percent (dry basis), and preferably from 22 to 27 weight percent (dry basis), sweetener (other than corn syrup); from about 0.1 to about 0.5 weight percent, and preferably from about 0.2 to about 0.25 weight percent (dry basis), emulsifier; from about 3 to about 9 weight percent, and preferably from about 4 to about 6 weight percent, fat; and at least about 92 weight percent solids, generally from about 92 to 96 weight percent, and preferably from 93 to 95 weight percent solids. Further, the cooked core does not require starch or hydrogenated starch hydrolysate to provide a chewable matrix for the core. Particulate antacids which may be used as actives in making the chewable product include aluminum carbonate, aluminum hydroxide, aluminum hydroxide-magnesium hydroxide which may be a dried gel, aluminum hydroxide-magnesium trisilicate which may be a dried gel, aluminum phosphate, aluminum hydroxy carbonate, dihydroxy aluminum sodium carbonate, aluminum magnesium glycinate, dihydroxy aluminum aminoacetate, dihydroxyaluminum aminoacetate, bismuth aluminate, bismuth carbonate, bismuth subcarbonate, bismuth subgallate, bismuth subnitrate, calcium carbonate, calcium citrate, calcium phosphate, hydrated magnesium aluminate activated sulfate, magmesium aluminate, magnesium aluminosilicate, magnesium carbonate, magnesium glycinate, magnesium hydroxide, magnesium oxide and magnesium trisilicate. Particulate mineral alkaline antacids, such as aluminum carbonate, aluminum hydroxide, calcium carbonate, magnesium carbonate, magnesium hydroxide and magnesium hydroxide are common and are preferred. In addition to gum arabic, xanthan gum, carrageenan gum, locust bean gum, karaya gum, acacia gum and guar gum may be used as gums as described herein.

The amount of emulsifier in the product prevents solids from separating from the product both during making the product with an aqueous slurry and after the product is cooked and extruded. As previously described, the gum/emulsifier/fat combination provides a matrix so that the fat stays within the matrix and the solids will not separate from the product during and after processing. The emulsifier fat ratio in the core is from 0.04 to 1.2 on a wet basis.

The method for making the product includes weighing corn syrup 2, fat 3, a non invert sugar 4, emulsifier 5 and texturizing/calcium solution 6 are weighed into vessel 8. Then moving these ingredients via line 9 to a mixer 10 and slurrying the corn syrup, fat, a non invert sugar such as sucrose, glucose, mannose, galactose, ribose, lactose and maltose among others and emulsifier, gum arabic and additional texturizing agents, particulate active, such as an antacid, and water to provide an aqueous slurry of from about to about 20 to about 45 weight percent corn syrup, preferably from about 34 to about 37 weight percent corn syrup, from 0.1 to 2.0 weight percent, preferably from 0.1 to 0.3 weight percent, emulsifier, from 3.0 to 9.0 weight percent, and preferably from 4 to 6 weight percent, fat, from 0.5 to 2 weight percent gum, and at least 10 weight percent active, such as particulate antacid, generally from 15 to 20 weight percent particulate active, preferably from 16 to 18 weight percent particulate active. The percentages in the slurry are on a wet basis and are wet percentages. The slurry comprises at least about 67 weight percent solids, generally from 68 to 84 weight percent, and preferably from about 72 to about 75 weight percent solids, and from about 25 to about 28 weight percent water. Sucrose is a preferred sweetener/sugar. But sugar alcohols may be used as sweeteners in lieu of corn syrup and sugars/carbohydrates. The combination of corn syrup and sweetener should comprise from about 60 to about 80 weight percent (dry basis), and preferably from about 67 to about 72 weight percent (dry basis), of the slurry. Corn syrup comprises from about 40 to about 70 weight percent (dry basis), preferably from about 55 to about 65 weight percent (dry basis) of the corn syrup/sweetener combination.

By way of example, the emulsifier may include lecithin and glyceryl monostearate. The texturizing agents may include by way of example dextrin, soluble fibers, gelatin and modified food starch.

The aqueous slurry when a chew fortified with an antacid is made has at least about 10 weight percent particulate active, such as antacid, on a wet basis and at least about 68 weight percent solids, then is transported via line 11 to a cooker 12 where 70 to 80 percent of the water in the slurry is removed to provide a post cooked soft chew intermediate product. During cooking, an optional vacuum may be drawn via pump 13 and sufficient amounts of water are removed to permit the further post cook addition of additional particulate antacid, other particulate actives and flavors and optionally other solids, yet retain the organoleptic properties of a final chew confectionary product which will have at least 10 weight percent, generally from 30 to 40 weight percent (dry basis), and preferably from 33 to 36 weight percent (dry basis) particulate antacid and/or other active; from about 0.1 to about 2 weight percent (dry basis), and preferably from about 0.5 to about 1 weight percent (dry basis) gum; from about 20 to about 40 weight percent, and preferably from 30 to 35 weight percent (dry basis) corn syrup; from about 20 to about 40 weight percent (dry basis), and preferably from 20 to 27 weight percent (dry basis) sweetener (other than corn syrup); from about 0.1 to about 0.5 weight percent, and preferably from about 0.2 to about 0.25 weight percent (dry basis) emulsifier; from about 3 to about 9 weight percent, and preferably from about 4 to about 6 weight percent, fat; and at least about 92 weight percent solids, generally from about 92 to 96 weight percent, and preferably from 93 to 95 weight percent solids. Sugar alcohols may be used as sweeteners in lieu of corn syrup and sugars/carbohydrates.

Generally, the slurry is cooked at about 113° C. to about 117° C. at atmospheric pressure for a time which is effective for providing a confectionary product with an antacid or other active, corn syrup, sweetener and solids content as previously described. Generally cooking the product at 113° C. to about 117° C. for about 20 to about 45 seconds is effective to remove at least 70 weight percent and generally from about 70 to about 80 weight percent water from the slurry. This provides a cooked slurry having at least about 90 weight percent, and generally from about 90 weight percent to about 96 weight percent solids, preferably from about 92 to about 94 weight percent solids.

After cooking, particulate antacid, other particulate actives and flavors are blended with the cooked slurry in mixer 16. Approximately 50 weight percent of the particulate active/antacid is added to the product post cooking. The temperature at which the additional particulate antacid, other actives and flavors are blended is relatively high to substantially preclude formation of a crystalline matrix of sugar, corn syrup and particulate antacid which will provide an overly firm product and which will adversely affect further processing of extrusion and packaging. This is important because the crystalline matrix of the product will begin to form if the product is too cool, resulting in an extremely firm mass which can not proceed through the rest of the process of extrusion and forming. Generally the mixing is done when the mass is in a liquid/semi solid state and at a temperature of at least about 100° C., and generally from about 105° C. to about 110° C. for about 5 to about 10 minutes. From about 40 to about 60 weight percent particulate antacid and particulate actives (based upon the total antacid and actives dry basis in the finished product) is added during the post cook mixing. The mixing paddle is rotated relatively quickly to incorporate the additional antacid and other potential active ingredients in the form of particulate solids into the post cooked product.

After the mixing at elevated temperatures, the mixed product mass with additional particulate antacid, actives and flavor is conveyed as a viscous mass via line 20 having a temperature of about 100° C. onto a cooling drum 22 having a temperature of from about 14 to about 20° C., and generally about 17° C. where the product is converted into a planar web having a temperature of not over about 50° C., and generally about 40° C. to about 45° C. That planar web is conveyed onto a transfer belt 24 where the surface of the web is coated with powdered sugar and optionally with additional actives. Thereafter the sugared web is conveyed to an extruder 26, which generally is a twin screw extruder where the product is heated, formed and extruded.

The temperature of the extruder entry point is about 46° C., and in the extruder sugared product undergoes further mixing with shear which keeps the product malleable for subsequent processing, coating and forming. The extruder head is set for about 43 to 50° C. and the sugared mass is extruded into a rope for further forming.

After extrusion, the product is sized with a standard rope sizer 28, put through a uniplast 30 which is a series of dies which forms round pieces, then cooled to a temperature of from about 0° to about 15° C.

The cooled sized product is precoated with an aqueous solution of gum, such as gum arabic, and corn syrup. The precoated product is cured at about 50° C. to about 60° C. to an RH of less than about 40% to allow the moisture to equilibrate in the product and allow the precoat barrier to harden providing a moisture barrier and surface texture to accept the final sugar/fat/chocolate coating. Thereafter the cured product is coated with sugar, sugar alcohols, chocolate, or hard fat by traditional confectionery techniques, including panning techniques as are known. The sugar and sugar alcohol coatings are substantially crystallized. The chocolate coating includes a fat which has a melting point of at least about 100° F. The finished product comprises from about 20 weight percent to about 28 weight percent coating which is in an amount and thickness which are effective for keeping the core from loosing or gaining more than 2 weight percent moisture over a storage period of 18 months at ambient temperature. Generally the coatings are thin, about 1 mm to 2 mm thick, which thickness is particularly appropriate for a 4 gram finished product comprising 20-28 weight percent coating.

### EXAMPLE

Final Center Formula

| Ingredient | % solids | PC % | Dry % |
|---|---|---|---|
| Sucrose | 100.00% | 21.81% | 23.30% |
| Corn syrup | 100.00% | 30.23% | 32.29% |
| Coconut Oil | 100.00% | 4.66% | 4.98% |
| Water | 0.00% | 6.38% | 0.00% |
| Gum Arabic | 100.00% | 0.83% | 0.89% |
| Lecithin | 100.00% | 0.20% | 0.21% |
| Calcium Carbonate - Slurry | 100.00% | 17.34% | 18.52% |
| Flavor | 100.00% | 0.65% | 0.70% |
| Icing Sugar | 90.00% | 1.88% | 2.01% |
| Calcium Carbonate - Mixing Pt | 100.00% | 16.02% | 17.11% |
| Total | | 100.00% | 100.00% |

Final Calcium Carbonate % = 33.36%
Center Weight (g) = 3.75
Calcium (mg)/Center = 500.3

Batch Through Cooker

| Ingredient | Wet % | % Solids | PC % | Dry Wt % | Dry % |
|---|---|---|---|---|---|
| Sucrose | 31.90% | 67.00% | 26.84% | 2.614 | 29.05% |
| Corn syrup | 36.80% | 80.50% | 37.21% | 3.624 | 40.27% |
| Coconut Oil | 4.57% | 100.00% | 5.74% | 0.559 | 6.21% |
| Water | 8.65% | 0.00% | 7.60% | 0.000 | 0.00% |
| Gum Arabic | 0.90% | 90.50% | 1.07% | 0.099 | 1.10% |
| Lecithin | 0.19% | 100.00% | 0.25% | 0.024 | 0.27% |
| Calcium Carbonate - Slurry | 16.99 | 100.00% | 21.34% | 2.078 | 22.09% |
| Total | 100.00% | | 100.00% | 8.998 | 100.00% |

Batch Recipe

| Ingredient | Wet % | % Solids | PC % | Dry % |
|---|---|---|---|---|
| Sucrose | 31.90% | 67.00% | 21.41% | 29.10 |
| Corn syrup | 36.80% | 80.50% | 29.68% | 40.34% |
| Coconut Oil | 4.57% | 100.00% | 4.58% | 6.22% |
| Cal./Gum. Solution | 26.54% | 67.32% | 17.86% | 24.26% |
| Lecithin | 0.19% | 100% | 0.19% | 0.26% |
| Water | 0.00% | 0.00% | 26.38% | 0.00% |
| Total | 100.00% | | 100.00% | 100.00% |

% solids = 73.62%

Calcium/Gum Solution Recipe

| Ingredient | Wet % | % Solids | PC % | Dry % |
|---|---|---|---|---|
| Water | 32.60% | 0.00% | 32.92% | 0.00% |
| Gum Arabic | 3.38% | 90.50% | 3.06% | 4.56% |
| Calcium Carbonate - | 64.02% | 100% | 64.02% | 94.44% |
| Slurry | | | | |
| Total | 100.00% | | 100.00% | 100.00% |

% solids = 67.08%

What is claimed is:

1. A confectionary product having a cooked, soft chewy confectionary core with a coated surface selected from the group consisting of substantially crystallized sugar, substantially crystallized sugar alcohols and chocolate having a melting point of at least about 1 00F., the cooked, soft confectionary core comprising:
at least about 10 weight percent (dry basis) particulate antacid mineral;
from about 0.1 to about 2.0 weight percent (dry basis) gum distributed throughout the core;
from 20 to 40 weight percent (dry basis) corn syrup solids,
from 20 to 40 weight percent (dry basis) from a sweetener selected from a group consisting of sugar other than from corn syrup solids, sugar alcohols and mixtures thereof;
from about 0.1 to about 0.5 weight percent (dry basis) emulsifier;
from 3 to 9 weight percent (dry basis) fat;
from 5 to 8 weight percent water; and
at least about 92 weight percent solids in the core.

2. The confectionary product of claim 1, wherein emulsifier to fat ratio in the core is from 0.04 to 1.2 on a wet basis.

3. The confectionary product of claim 2, wherein the core comprises at least 30 weight percent (dry basis) particulate antacid mineral, the coating is thin, completely surrounds the core, comprises from about 20 to 28 weight percent of the confectionary and is effective for protecting the core from a water loss or gain of not more than about 2 weight percent for at least 18 months at ambient temperature.

4. The confectionary product of claim 3, wherein the antacid includes calcium carbonate.

5. The confectionary product of claim 3, wherein the core is non-aerated and comprises from 20 to 40 weight percent (dry basis) corn syrup solids and from 20 to 40 weight percent (dry basis) of a sugar from other than corn syrup solids; and from 92 to 96 weight percent solids.

6. The confectionary product of claim 5, wherein the core comprises from 33 to 36 weight percent (dry basis) particulate antacid mineral.

7. A method for making a fortified chewy confectionary coated with a coating selected from the group consisting of substantially crystallized sugar, substantially crystallized sugar alcohols and chocolate having a melting point of at least about 100° F. hard sugar coating, the method comprising:
slurrying corn syrup, fat, a non invert sugar, an emulsifier, gum, particulate antacid mineral and water to provide an aqueous slurry having from about to about 20 to 45 weight percent corn syrup, emulsifier, fat, gum, and at least 15 weight percent particulate antacid mineral;
cooking the aqueous slurry at about 113° C. to about 117° C. for about 20 to about 45 seconds and effective to remove at least 70 weight percent water from the slurry to provide a cooked slurry having at least about 90 weight percent solids;
blending additional solids including particulate antacid mineral to the cooked slurry at a temperature of from about 105 degrees C. to 110 degrees C. to provide mixed product mass having at least 92 weight percent total solids to provide a viscous blended product;
cooling the viscous blended product to a temperature of not more than about 50° C.;
extruding the cooled viscous blended product;
pelletizing the extruded product into pieces to provide a pelletized product; and
coating the pelletized product with the coating to provide a confectionary product having a cooked, soft, chewy confectionary core with a coated surface, the soft confectionary core comprising:
at least about 10 weight percent (dry basis) particulate antacid mineral;
from 0.1 to about 2.0 weight percent (dry basis) gum distributed throughout the core;
from 20 to 40 weight percent (dry basis) of corn syrup solids;
from 20 to 40 weight percent (dry basis) of a sweetener selected from a group consisting of sugar other than from corn syrup solids, sugar alcohols and mixtures;
from 0.2 to 0.25 weight percent (dry basis) emulsifier;
from 3 to 9 weight percent (dry basis) fat;
from 6 to 8 weight percent water; and
at least about 92 weight percent solids.

8. The method of claim 7 wherein sufficient particulate antacid mineral is mixed with the slurry and the cooked slurry to provide an extruded product with at least about 30 weight percent (dry basis) of particulate antacid mineral.

9. The method of claim 8 wherein emulsifier to fat ratio in the core is from 0.04 to 1.2 on a wet basis.

10. The method of claim 9, wherein the core is non-aerated and comprises from 20 to 40 weight percent (dry basis) corn syrup solids;
from 20 to 40 weight percent (dry basis) of a sugar from other than corn syrup solids; and
from 92 to 96 weight percent solids, and the coating is selected from the group consisting of substantially crystallized sugar and substantially crystallized sugar alcohols, is thin, completely surrounds the core, comprises from about 20 to 28 weight percent of the confectionary and is effective for protecting the core from a water loss or gain of not more than about 2 weight percent for at least 18 months at ambient temperature.

11. The method of claim 10, wherein the antacid includes calcium carbonate.

12. The method of claim 11, wherein the core comprises from 33 to 36 weight percent (dry basis) particulate antacid mineral.

13. A method for making a fortified chewy confectionary coated with a hard thin coating, the method comprising:
slurrying corn syrup, fat, a non invert sugar, an emulsifier, gum, particulate antacid mineral and water to provide an aqueous slurry having from about to about 20 to 45 weight percent corn syrup, from 0.1 to 2 weight percent (wet basis) emulsifier, from 3 to 9 weight percent (wet basis) fat, from about 0.5 to 2 weight percent (wet basis) gum, and from 10 to 20 weight percent (wet basis) particulate antacid mineral;
cooking the aqueous slurry at about 113° C. to about 117° C. for about 20 to about 45 seconds and effective to remove at least 70 weight percent water from the slurry to provide a cooked slurry having at least about 90 weight percent solids;
blending additional particulate antacid mineral to the cooked slurry at a temperature of from about 105 degrees C. to 110 degrees C. to provide mixed product mass having at least 92 weight percent particulate antacid mineral to provide a viscous blended product;
cooling the viscous blended product to a temperature of 40° to about 50° C.;
extruding the cooled viscous blended product;
pelletizing the extruded product into pieces to provide a pelletized product; and coating the pelletized product with a hard coating selected from the group consisting of substantially crystallized sugar and substantially crystallized sugar alcohols to provide a confectionary product having a soft chewy confectionary core with a hard coated surface which is effective for protecting the core from a water loss or gain of not more than about 2 weight percent for at least 18 months at ambient temperature, the soft confectionary core comprising:
at least about 30 weight percent (dry basis) particulate antacid mineral;
from 0.1 to about 2.0 weight percent (dry basis) gum distributed throughout the core;
from 20 to 40 weight percent (dry basis) corn syrup solids;
from 20 to 40 weight percent (dry basis) of a sweetener selected from a group consisting of sugar other than from corn syrup solids, sugar alcohols and mixtures thereof,
from about 0.2 to about 0.25 weight percent (dry basis) emulsifier;
from 3 to 9 weight percent (dry basis) fat;
from 6 to 8 weight percent water; and
at least about 92 weight percent solids.

14. The method of claim 13 wherein emulsifier to fat ratio in the core is from 0.04 to 1.2 on a wet basis.

15. The method of claim 14, wherein the coating comprises from about 20 to about 28 weight percent of the coated confectionary and the core is non-aerated and comprises from 20 to 40 weight percent (dry basis) corn syrup solids;
from 20 to 40 weight percent (dry basis) sugar other than from corn syrup solids; and
from 92 to 96 weight percent solids.

16. The method of claim 15, wherein the antacid includes calcium carbonate.

17. The method of claim 15, wherein the core comprises from 33 to 36 weight percent (dry basis) particulate antacid mineral.

18. A fortified chewy confectionary coated with a coated with a hard thin coating which confectionary product coated with a hard thin coating is made by
slurrying corn syrup, fat, a non invert sugar, an emulsifier, gum, particulate antacid mineral and water to provide an aqueous slurry having from about to about 20 to 45 weight percent corn syrup, emulsifier, fat, gum, and at least 15 weight percent particulate antacid mineral;
cooking the aqueous slurry at about 113° C. to about 117° C. for about 20 to about 45 seconds and effective to remove at least 70 weight percent water from the slurry to provide a cooked slurry having at least about 90 weight percent solids;
blending additional solids including particulate antacid mineral to the cooked slurry at a temperature of from about 105 degrees C. to 110 degrees C. to provide mixed product mass having at least 92 weight percent total solids to provide a viscous blended product;
cooling the viscous blended product to a temperature of not more than about 50° C.;
extruding the cooled viscous blended product;
pelletizing the extruded product into pieces to provide a pelletized product; and
coating the pelletized product with a hard thin coating selected from the group consisting of substantially crystallized sugar and substantially crystallized sugar alcohols to provide a confectionary product having a soft chewy confectionary core with a hard coated surface which is effective for protecting the core from a water loss or gain of not more than about 2 weight percent for at least 18 months at ambient temperature, and the confectionary product having a cooked, soft chewy confectionary core with the coated surface, the soft confectionary core comprising:
at least about 10 weight percent (dry basis) particulate antacid mineral;
from 0.1 to about 2.0 weight percent (dry basis) gum distributed throughout the core;
from 20 to 40 weight percent (dry basis) of a sweetener selected from a group consisting of corn syrup solids, sugar other than from corn syrup solids, sugar alcohols and mixtures thereof, from about 0.2 to about 0.25 weight percent (dry basis) emulsifier;
from 3 to 9 weight percent (dry basis) fat;
from 6 to 8 weight percent water; and
at least about 92 weight percent solids.

19. The fortified chewy confectionary coated with a hard sugar coating of claim 18, wherein the corn syrup, fat, the non invert sugar, the emulsifier, the gum, particulate antacid mineral and water are slurried to provide an aqueous slurry having from about to about 20 to 45 weight percent corn syrup, from 0.1 to 2 weight percent (wet basis) emulsifier, from 3 to 9 weight percent (wet basis) fat, from about 0.5 to 2 weight percent (wet basis) gum, and from 10 to 20 weight percent (wet basis) particulate antacid mineral; the viscous blended product is cooled to a temperature of 40° to about 50° C.; the confectionary core has at least about 30 weight percent particulate antacid mineral and from 92 to 96 weight percent solids and the coating comprising from about 20 to about 28 weight percent of the coated confectionary.

20. The fortified chewy confectionary coated with a hard sugar coating of claim 19, wherein the antacid includes calcium carbonate.

21. The fortified chewy confectionary coated with a hard sugar coating of claim 19 wherein emulsifier to fat ratio in the core is from 0.04 to 1.2 on a wet basis.

22. The fortified chewy confectionary coated with a hard sugar coating of claim 21, wherein the core is non-aerated and comprises from 20 to 40 weight percent (dry basis) corn syrup solids; and from 20 to 40 weight percent (dry basis) sugar other than from corn syrup solids.

23. The fortified chewy confectionary coated with a hard sugar coating of claim 22, wherein the core comprises from 33 to 36 weight percent (dry basis) particulate antacid mineral.

24. A confectionary product having a cooked, soft chewy confectionary core with a hard crystallized sugar coated surface, the cooked, soft confectionary core comprising:
at least about 30 weight percent (dry basis) particulate active ingredient;
gum;
corn syrup solids;
sweetener selected from a group consisting of sugar other than from corn syrup solids, sugar alcohols and mixtures thereof;
emulsifier;
fat; and
the core having at least about 92 weight percent solids, and the water, the gum, emulsifier and fat in amounts effective to make the cooked core a matrix which keeps the fat within the matrix and permit the core to deliver the active as a part of a non-gritty core, the sugar coating having a thickness and being effective for preventing a water loss or gain in the core of not more than 2 weight percent for at least 18 month at ambient temperature.

25. The confectionary product of claim 24, wherein the core comprises at least 30 weight percent (dry basis) particulate active and the coating comprises from about 20 to about 28 weight percent of the coated confectionary product.

26. The confectionary product of claim 25, wherein the particulate active is an antacid.

27. The confectionary product of claim 26, wherein the core comprises from 33 to 36 weight percent (dry basis) particulate antacid mineral.

28. The confectionary product of claim 25, wherein the core of the product is non-aerated, includes 92 to 96 weight percent solids and includes from about 0.1 to about 2.0 weight percent (dry basis) gum distributed throughout the core;
from 20 to 40 weight percent (dry basis) corn syrup solids,
from 20 to 40 weight percent (dry basis) of the sweetener;
from about 0.1 to about 0.5 weight percent (dry basis) emulsifier;
from 3 to 9 weight percent (dry basis) fat;
from 5 to 8 weight percent water; and
the emulsifier to fat ratio in the core being from 0.04 to 1.2 on a wet basis.

29. The confectionary product of claim 26, wherein the core of the product is non-aerated has 92 to 96 weight percent solids and includes from about 0.1 to about 2.0 weight percent (dry basis) gum distributed throughout the core;
from 20 to 40 weight percent (dry basis) corn syrup solids,
from 20 to 40 weight percent (dry basis) of the sweetener;
from about 0.1 to about 0.5 weight percent (dry basis) emulsifier;
from 3 to 9 weight percent (dry basis) fat;
from 5 to 8 weight percent water; and
the emulsifier to fat ratio in the core being from 0.04 to 1.2 on a wet basis.

30. The confectionary product of claim 29, wherein the antacid includes calcium carbonate.
